(19) United States
(12) Patent Application Publication
(10) Pub. No.: US 2015/0044640 A1
(43) Pub. Date: Feb. 12, 2015

(54) ENDODONTIC POST ASSEMBLY AND METHODS OF PRODUCING AND USING THE SAME

(71) Applicant: TAIWAN GREEN POINT ENTERPRISES CO., LTD., Taichung City (TW)

(72) Inventor: Pi-Ying LIU, Taichung City (TW)

(73) Assignee: TAIWAN GREEN POINT ENTERPRISES CO., LTD., Taichung City (TW)

(21) Appl. No.: 14/152,352

(22) Filed: Jan. 10, 2014

(30) Foreign Application Priority Data
Aug. 8, 2013 (CN) 201310344657.5

(51) Int. Cl. A61C 5/04; B29C 45/00; B29C 71/00; B65B 55/02

(52) U.S. Cl. CPC A61C 5/04; B65B 55/02; B29C 45/0053; B29C 71/00; B29C 2045/0077; B29L 2031/7546
USPC 433/224; 53/425; 264/328.1; 264/161

(57) ABSTRACT

An endodontic post assembly includes a connecting member and a plurality of post structures. The connecting member includes a base and a plurality of connecting nodes connected to the base. Each of the post structures has a root portion connected to a respective one of the connecting nodes, and an apical portion opposite to the root portion. A method of producing the endodontic post assembly and a method of using a sterilization package in endodontic treatment are also provided.

### CROSS-REFERENCE TO RELATED APPLICATION

This application claims priority of Chinese Patent Application No. 201310344657.5, filed on Aug. 8, 2013.

### BACKGROUND OF THE INVENTION

1. Field of the Invention

The invention relates to an endodontic post, more particularly to an endodontic post assembly and methods of producing and using the endodontic post assembly.

2. Description of the Related Art

During endodontic treatment, dentists may need to place endodontic posts into root canals of a tooth for reinforcing the structural strength of the tooth and for supporting a crown if needed.

Conventionally, the endodontic posts are produced by cutting and turning into limited kinds of shapes, and the production costs thereof are relatively high. Besides, the manufactured endodontic posts with various sizes and shapes usually are stored in a package box. The dentists may need to choose an appropriate post with a desired shape and size, followed by sterilizing the chosen endodontic post before placing into the root canal so as to avoid bacterial infection. However, the sterilization process is usually time-consuming and inconvenient for dentists.

### SUMMARY OF THE INVENTION

Therefore, one object of the present invention is to provide an endodontic post assembly that may alleviate the aforementioned drawbacks of the prior art. Another object of the present invention is to provide a method of producing the endodontic post assembly. Yet another object of the present invention is to provide a method of using the endodontic post assembly.

According to one aspect of the present invention, an endodontic post assembly includes a connecting member and a plurality of post structures.

The connecting member includes a base and a plurality of connecting nodes connected to the base.

Each of the post structures has a root portion connected to a respective one of the connecting nodes, and an apical portion opposite to the root portion.

According to another aspect of the present invention, a method of producing the endodontic post assembly includes the following steps of:

(a) preparing a thermoplastic material and an injection mold; and

(b) melting and injecting the thermoplastic material into the injection mold so as to form the endodontic post assembly.

According to yet another aspect of the present invention, a method of using a sterilization package in endodontic treatment includes the following steps of:

providing a sterilization package including a packaging container and an endodontic post assembly that is sterilized and packaged in the packaging container and that includes a connecting member and a plurality of post structures, the connecting member including a base and a plurality of connecting nodes connected to the base, each of the post structures having a root portion that is connected to a respective one of the connecting nodes and an apical portion that is opposite to the root portion;

opening the packaging container and extracting the endodontic post assembly; and

disconnecting at least one of the post structures from the connecting member.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of a first preferred embodiment of an endodontic post assembly according to the present invention;

FIG. 2 is a fragmentary side view of the first preferred embodiment;

FIG. 3 is a fragmentary top view of the first preferred embodiment;

FIG. 4 is a fragmentary perspective view of a variation of the first preferred embodiment;

FIG. 5 is a fragmentary top view of the first preferred embodiment illustrating that the endodontic post assembly is packaged in a packaging container;

FIG. 6 is a flow chart illustrating a method of producing the first preferred embodiment of the endodontic post assembly;

FIG. 7 is a flow chart illustrating a method of using a sterilization package containing the first preferred embodiment for endodontic treatment;

FIG. 8 is a top view of a second preferred embodiment of the endodontic post assembly according to the present invention; and

FIG. 9 is a top view of a variation of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

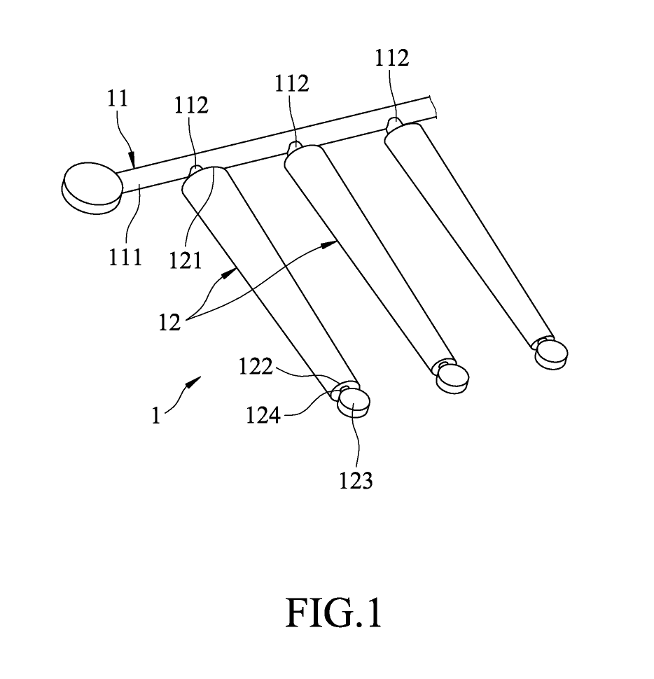

Referring to FIGS. 1 to 3, the first preferred embodiment of an endodontic post assembly 1 according to the present invention includes a connecting member 11 and a plurality of post structures 12.

The connecting member 11 includes a base 111, and a plurality of connecting nodes 112 connected to the base 111. In this embodiment, each of the connecting nodes 112 has a neck portion 113 that is connected to a respective one of the post structures 12. In this embodiment, the base 111 of the connecting member 11 is configured as a strip and the connecting nodes 112 are equidistantly spaced apart from each other and connected to the base 111.

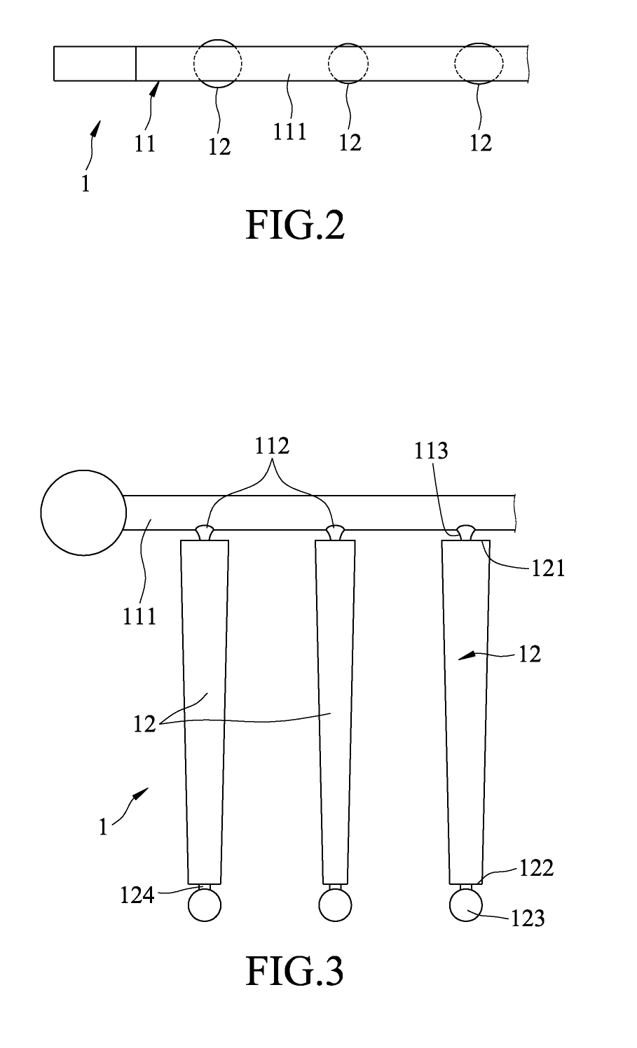

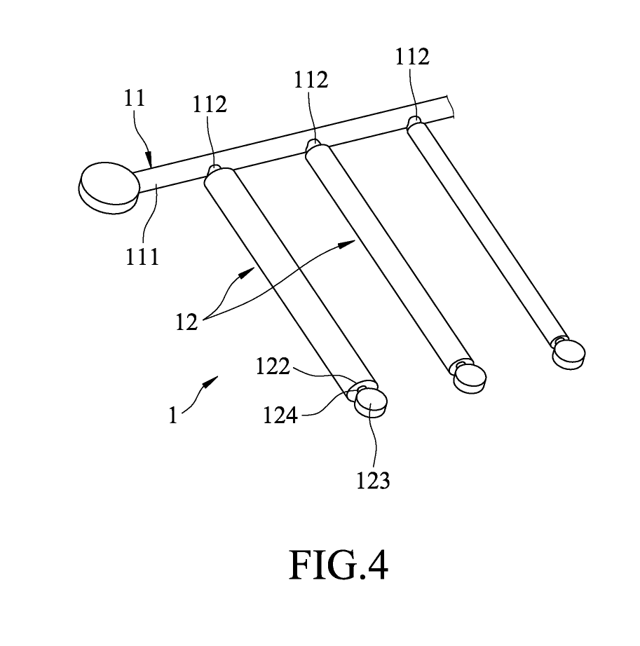

Each of the post structures 12 has a root portion 121 that is connected to the neck portion 113 of a respective one of the connecting nodes 112, and an apical portion 122 that is opposite to the root portion 121. In this embodiment, the apical portion 121 of each of the post structures 12 has a diameter larger than that of the neck portion 113 of the respective one of the connecting nodes 112. The root portion 121 may have a diameter that is larger than that of the apical portion 122 in order to fit into a root canal during endodontic treatment. However, the diameter of the root portion 121 may be identical to that of the apical portion 122 (see FIG. 4). In this embodiment, each of the post structures 12 is tapered from the root portion 121 to the apical portion 122 and has a circular cross-section (see FIG. 2), but the shape of the post structures 12 is not limited hereto and can vary according to various demands in endodontic treatment due to various shapes and sizes of root canals (e.g., the post structure 12 may have an elliptical cross-section).

In this embodiment, the connecting member 11 and the post structures 12 of the endodontic post assembly 1 are formed as one piece by injection molding. When the endodontic post assembly 1 is made of a thermoplastic material using a mold, the endodontic post assembly 1 may further include a plurality of flash blocks 123 due to excess amount of the thermoplastic material. Each of the flash blocks 123 has a connecting segment 124 that is connected to the apical portion 122 of a respective one of the post structures 12 and that has a diameter smaller than that of the apical portion 122 of the respective one of the post structures 12, so as to allow the flash blocks 123 to be easily torn off.

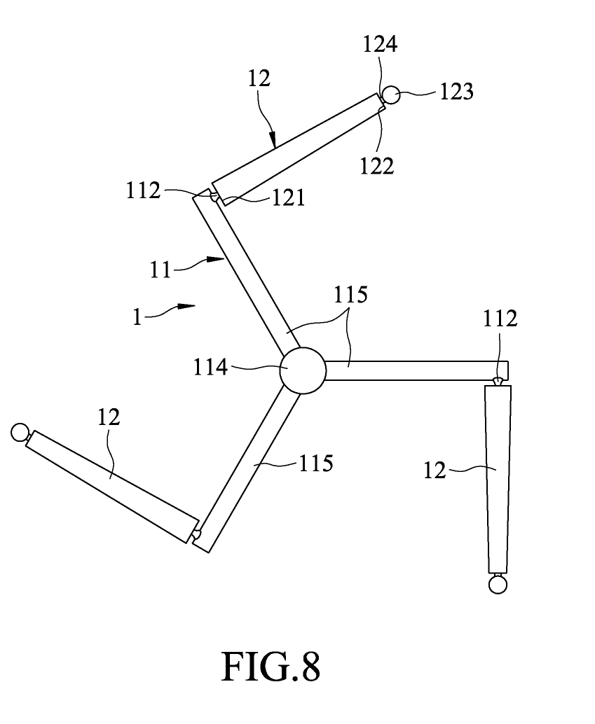

Referring to FIG. 8, the second preferred embodiment of the endodontic post assembly 1 according to the present invention is shown to be similar to that of the first preferred embodiment. The difference therebetween resides in that the base 111 of the connecting member 11 of the second preferred embodiment has a central portion 114 and a plurality of extending portions 115 extending outwardly from the central portion 114. Each of the connecting nodes 113 is connected to a distal end of a respective one of the extending portions 115.

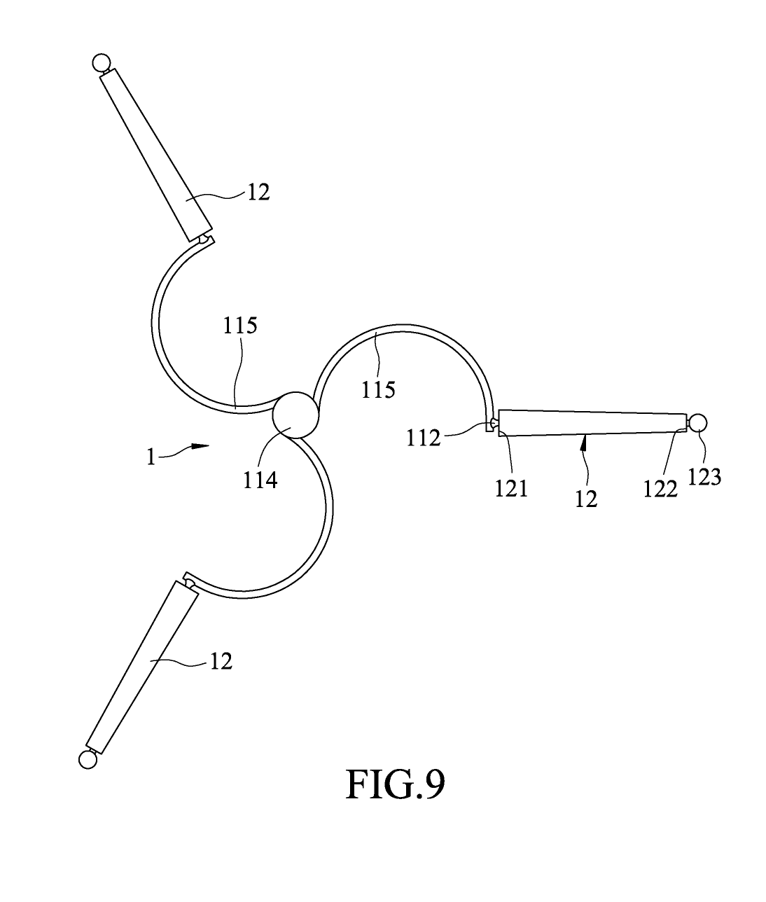

In this embodiment, each of the extending portions 115 is configured as a strip and is substantially perpendicular to the respective one of the post structures 12. However, the positional relationship between the extending portions 115 and the post structures 12 can vary based on actual requirements. Fox example, each of the extending portions 115 may extend along the same direction as the respective one of the post structures 12. Further referring to FIG. 9, the extending portions 115 of the base 111 of the connecting member 11 may be configured into other shapes, such as an arc.

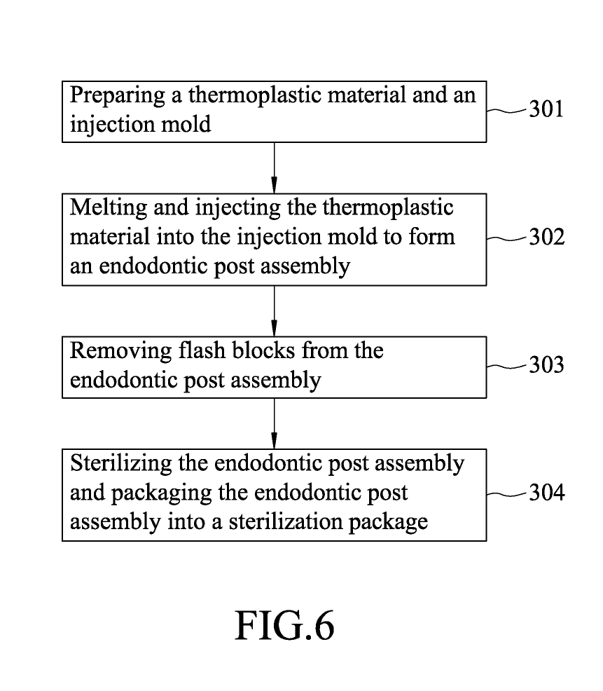

Referring to FIGS. 3, 5 and 6, a method of producing the endodontic post assembly 1 of the first preferred embodiment according to the present invention includes the following steps:

Step 301: preparing a thermoplastic material and an injection mold. In this embodiment, the thermoplastic material is glass fiber in the form of granules.

Step 302: melting and injecting the thermoplastic material into the injection mold so as to form the endodontic post assembly 1.

Step 303: removing each of the flash blocks 123 from the apical portion 122 of the respective one of the post structures 12 of the endodontic post assembly 1.

Step 304: sterilizing the endodontic post assembly 1 after Step 303 and packaging the endodontic post assembly in a packaging container 2 to obtain a sterilization package.

It is worth noting that the step 303 may be performed after step 304.

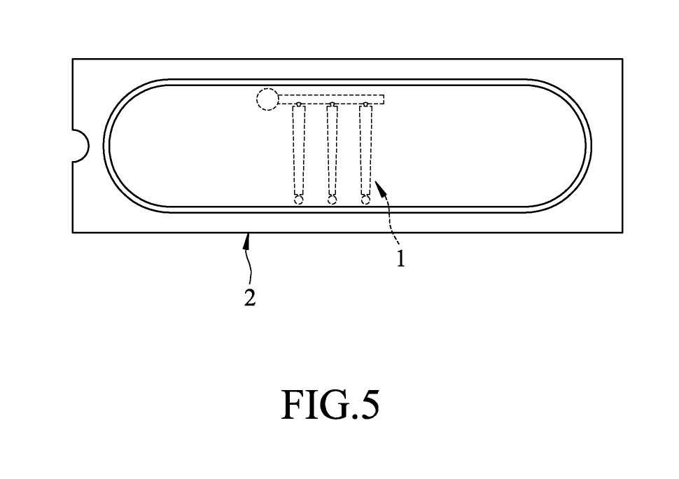

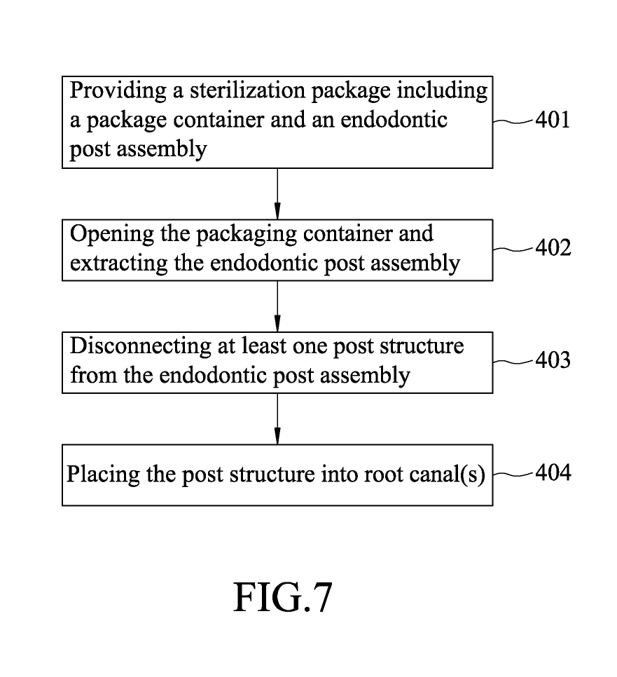

Referring to FIGS. 5 and 7, a method of using the sterilization package in endodontic treatment according to the present invention includes the following steps:

Step 401: providing the sterilization package.

Step 402: opening the packaging container 2 and extracting the endodontic post assembly 1.

Step 403: disconnecting at least one of the post structures 12 from the connecting member 11 at the corresponding neck portion(s) 113 (see FIG. 3).

Step 404: placing the at least one of the post structures 12 into the root canal(s) during the endodontic treatment.

Since the endodontic post assembly 1 is already sterilized, the post structures 12 can be used directly during the endodontic treatment. Further, the production cost of the endodontic post assembly 1 is relatively low, so that the remaining unused post structures 12 of the endodontic post assembly 1 can be discarded.

To sum up, the endodontic post assembly 1 of the present invention has the following advantages:

(i) The connecting member 11 and the post structures 12 are formed as one piece by injection molding, so that the production cost is relatively low and the shape and the size of the post structures 12 can be easily designed so as to fit into roof canals having various sizes and shapes.

(ii) Dentists can just disconnect the desired post structure(s) 12 from the connecting member 11 and use directly without further sterilization, since the endodontic post assembly 1 is already sterilized and packaged in the sterilization package.

(iii) The post structures 12 with various sizes and shapes can be presented in the same endodontic post assembly 1 and may correspond to root canals with various sizes and shapes.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An endodontic post assembly comprising:
a connecting member including a base and a plurality of connecting nodes connected to said base; and
a plurality of post structures each of which has a root portion connected to a respective one of said connecting nodes, and an apical portion opposite to said root portion.

2. The endodontic post assembly as claimed in claim 1, wherein said connecting member and said post structures are formed as one piece by injection molding.

3. The endodontic post assembly as claimed in claim 1, wherein each of said connecting nodes of said connecting member has a neck portion that is connected to the respective one of said post structures and that has a diameter smaller than that of said apical portion of said respective one of said post structures.

4. The endodontic post assembly as claimed, in claim 1, further comprising a plurality of flash blocks each of which is connected to said apical portion of a respective one of said post structures.

5. The endodontic post assembly as claimed in claim 1, wherein said base of said connecting member has a central portion and a plurality of extending portions extending outwardly from said central portion, each of said connecting nodes being connected to a distal end of a respective one of said extending portions.

6. The endodontic post assembly as claimed in claim 1, wherein each of said post structures is tapered from said root portion to said apical portion, and has a circular cross-section.

7. A method of producing an endodontic post assembly of claim 1, comprising the following steps of:
a) preparing a thermoplastic material and an injection mold; and
b) melting and injecting the thermoplastic material into the injection mold so as to form the endodontic post assembly of claim 1.

8. The method as claimed in claim 7, wherein the endodontic post assembly formed in step (b) includes a plurality of flash blocks, the method further comprising a step (c) of removing the flash blocks from the endodontic post assembly after step (b).

9. The method as claimed in claim 7, further comprising a step (d) of sterilizing the endodontic post assembly and packaging the endodontic post assembly into a sterilization package.

10. A method of using a sterilization package in endodontic treatment, comprising the following steps of:
providing a sterilization package including a packaging container and an endodontic post assembly that is sterilized and packaged in the packaging container and that includes a connecting member and a plurality of post structures, the connecting member including a base and a plurality of connecting nodes connected to the base, each of the post structures having a root portion that is connected to a respective one of the connecting nodes and an apical portion that is opposite to the root portion;
opening the packaging container and extracting the endodontic post assembly; and
disconnecting at least one of the post structures from the connecting member.
